(19) United States
(12) Patent Application Publication
(10) Pub. No.: US 2022/0226918 A1
(43) Pub. Date: Jul. 21, 2022

(54) SOLDERING IRON INCLUDING TEMPERATURE PROFILING AND METHOD OF USE

(71) Applicant: OK International, Inc., Cyprus, CA (US)

(72) Inventor: Hoa Dinh Nguyen, Santa Ana, CA (US)

(21) Appl. No.: 17/150,817

(22) Filed: Jan. 15, 2021

(51) Int. Cl. B23K 3/03; B23K 3/02

(52) U.S. Cl. CPC B23K 3/033; B23K 3/027

(57) ABSTRACT

A soldering iron with temperature profiling, comprising a hand piece or a robot arm including a soldering tip; a processor configured to provide temperature profiling where the soldering tip is one or more of the following during a soldering event: provided at multiple tip temperatures at fixed times during the soldering event; and provided at multiple tip temperatures at self-adjusting times during the soldering event.

### FIELD OF THE INVENTION

The disclosed invention relates generally to manufacturing, repair and rework of printed circuit boards (PCBs) using soldering, and more particularly to a soldering iron with temperature profiling.

### BACKGROUND

Two existing hand soldering systems that exist are adjustable tip temperature soldering systems, and fixed tip temperature soldering systems. Once the tip temperature is set for the soldering process in either of these systems, the tip temperature does not change during the soldering process. With smaller and smaller product package sizes, thermal shock, micro-cracking, etc. causes products to fail prematurely. Further, some applications require a printed circuit board (PCB) to be pre-heated to a preset temperature before physically contacting the tip to the component.

### SUMMARY OF THE INVENTION

An aspect of the invention involves a soldering iron system including temperature profiling, allowing an operator to set multiple tip temperatures at fixed times or self-adjustable times during a solder event.

Another aspect of the invention involves a soldering iron with temperature profiling, comprising: a hand piece or a robot arm including a soldering tip; a processor configured to: provide temperature profiling where the soldering tip is one or more of the following during a soldering event: provided at multiple tip temperatures at fixed times during the soldering event; and provided at multiple tip temperatures at self-adjusting times during the soldering event.

One or more implementations of the aspect described immediately above include one or more of the following: the soldering iron further includes a power supply unit; the soldering iron further includes a stand; the processor is in one or more of the stand, the power supply, and the hand piece or robot arm; the soldering iron includes a hand piece, and the handpiece includes the solder tip, a resistance temperature detector (RTD), a coil to generate a magnetic field, and a magnetic shield; the handpiece includes a ceramic insulator; the handpiece includes a shaft, shrink tube, and a connector; the processor is configured to provide temperature profiling where the soldering tip is provided at multiple tip temperatures at fixed startup, soak, and reflow times during the soldering event; the processor is configured to provide temperature profiling where the soldering tip is provided at multiple tip temperatures at self-adjusting startup, soak, and reflow times during the solder event; and/or the processor is configured to provide temperature profiling where the soldering tip is provided at multiple tip temperatures at both of the following during the soldering event: one or more fixed startup, soak, and reflow times; and self-adjusting startup, soak, and reflow times.

Another aspect of the invention involves a computer implemented method for temperature profiling with a soldering iron comprising a hand piece or a robot arm including a soldering tip, where one or more processors are programmed to perform steps comprising: providing temperature profiling where the soldering tip is one or more of the following during a soldering event: provided at multiple tip temperatures at fixed times during the soldering event; and provided at multiple tip temperatures at self-adjusting times during the soldering event.

One or more implementations of the aspect described immediately above include one or more of the following: providing temperature profiling where the soldering tip is provided at multiple tip temperatures at fixed startup, soak, and reflow times during the soldering event; providing temperature profiling where the soldering tip is provided at multiple tip temperatures at self-adjusting startup, soak, and reflow times during the solder event; providing temperature profiling where the soldering tip is provided at multiple tip temperatures at both of the following during the soldering event: one or more fixed startup, soak, and reflow times; and self-adjusting startup, soak, and reflow times.

A further aspect of the invention involves a non-transitory computer readable medium having stored thereon one or more sequences of instructions for causing one or more processors to perform the steps for temperature profiling with a soldering iron comprising a hand piece or a robot arm including a soldering tip, the steps comprising: providing temperature profiling where the soldering tip is one or more of the following during a soldering event: provided at multiple tip temperatures at fixed times during the soldering event; and provided at multiple tip temperatures at self-adjusting times during the soldering event.

One or more implementations of the aspect described immediately above include one or more of the following: providing temperature profiling where the soldering tip is provided at multiple tip temperatures at fixed startup, soak, and reflow times during the soldering event; providing temperature profiling where the soldering tip is provided at multiple tip temperatures at self-adjusting startup, soak, and reflow times during the solder event; providing temperature profiling where the soldering tip is provided at multiple tip temperatures at both of the following during the soldering event: one or more fixed startup, soak, and reflow times; and self-adjusting startup, soak, and reflow times.

### BRIEF DESCRIPTION OF DRAWINGS

FIG. 1 depicts an embodiment of a handheld soldering iron system including temperature profiling.

FIG. 2 is a perspective view of an embodiment of a variety of components of a soldering iron of the handheld soldering iron system including temperature profiling of FIG. 1A.

FIG. 3 is an additional perspective view of the soldering iron of FIG. 2 showing a variety of components of the soldering iron.

FIG. 4 is another perspective view of the soldering iron of FIG. 2 showing a variety of components of the soldering iron.

FIG. 5 is a further perspective view of the soldering iron of FIG. 2 showing a variety of components of the soldering iron.

FIG. 6 is a still further perspective view of the soldering iron of FIG. 2 showing a variety of components of the soldering iron.

FIG. 7 is a block diagram illustrating an example wired or wireless processor enabled device that may be used in connection with the embodiment(s) described herein.

### DETAILED DESCRIPTION OF THE INVENTION

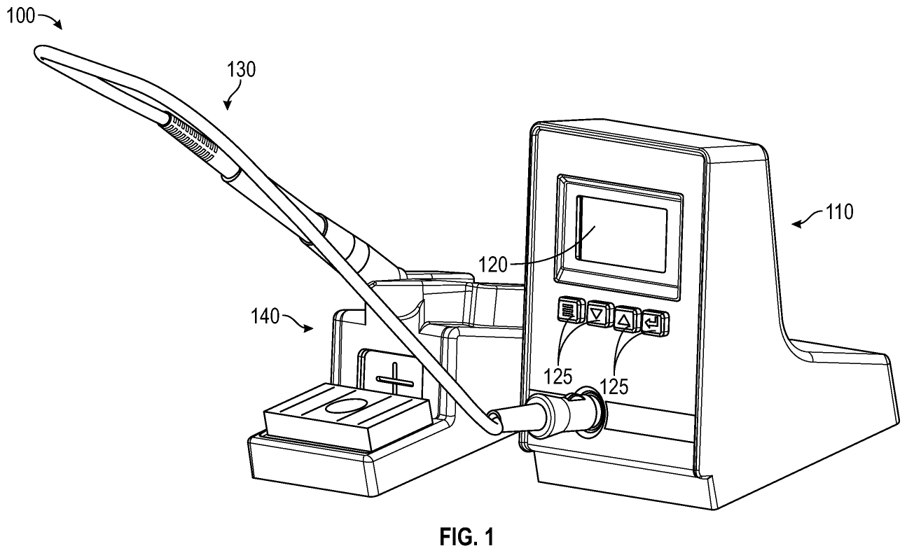

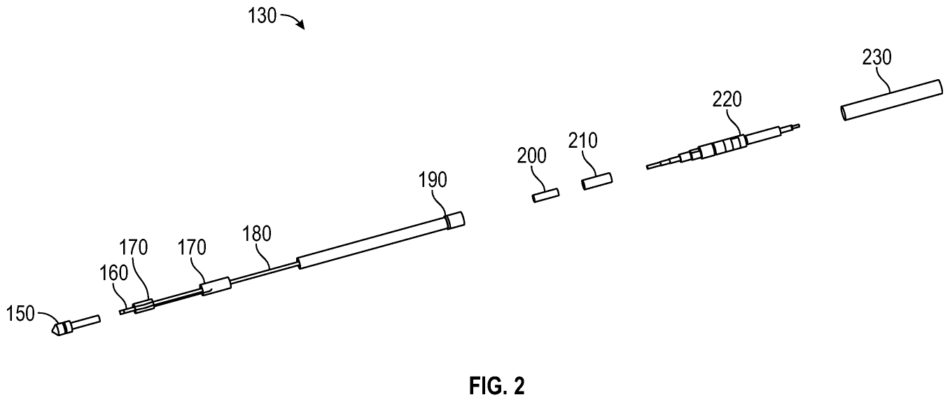

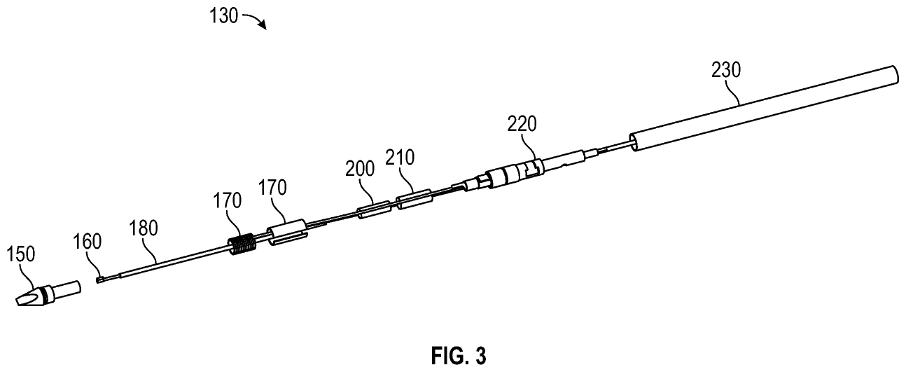

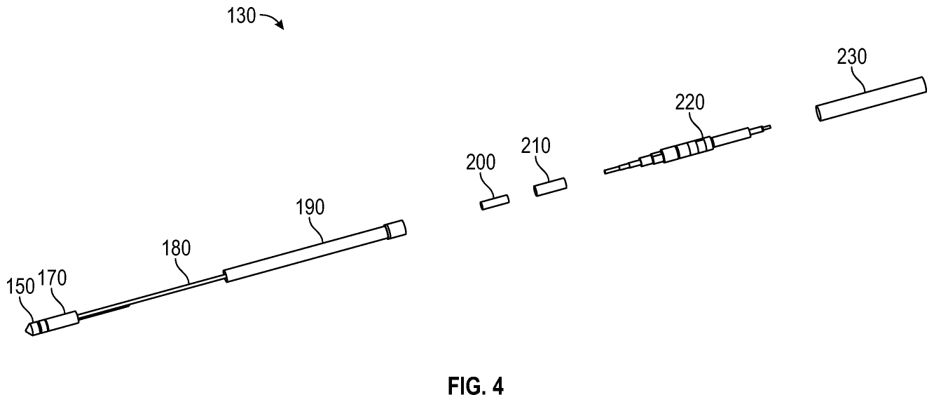

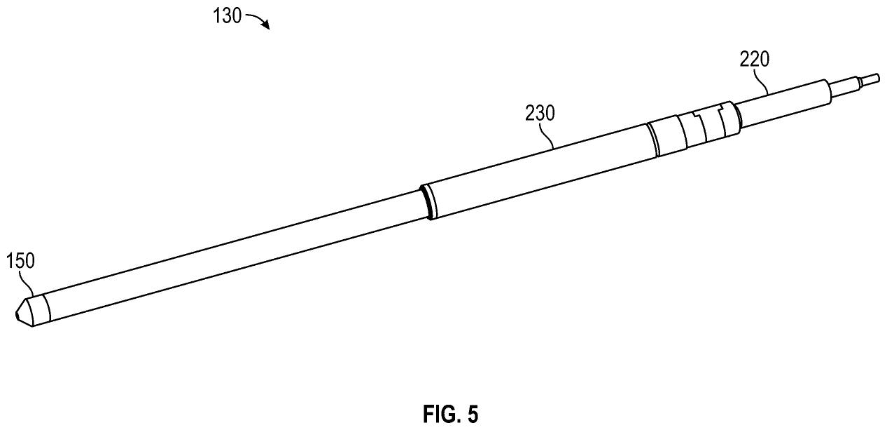

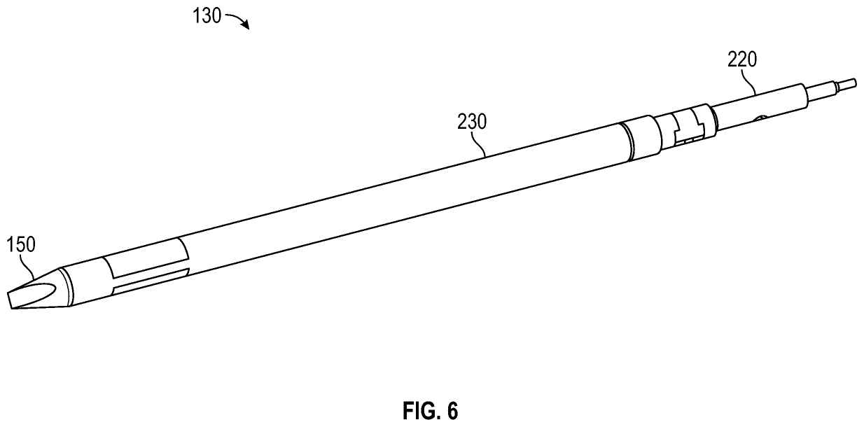

With reference to FIGS. 1-7, an embodiment of a handheld soldering iron system 100 including temperature profiling will be described. The handheld soldering iron system includes a processor, such as a microprocessor or controller, memory, input/output circuitry and other necessary electronic circuitry to perform the temperature profiling shown and/or described herein.

FIG. 1 depicts the handheld soldering iron system 100. As shown, the handheld soldering iron system includes a power supply unit 110 including a display 120 such as an LCD display, and various inputs 125. The soldering iron system 100 further includes a hand piece 130 coupled to the power supply unit 110 and a (work) stand 140 that accommodates the hand piece 130. The hand piece 130 receives power from the power supply unit 110 and heats a soldering tip attached to or located in a soldering cartridge to perform the soldering on a work piece.

In one or more embodiments, the power supply unit 110 and/or the hand piece 130 includes a microprocessor, memory, input/output circuitry and other necessary electronic circuitry to perform various processes such as those described herein. One skilled in the art would recognize that the microprocessor(s) (or the controller(s)) may be placed in one or more of the power supply unit 110, in the hand piece 130, or a stand 140 of the soldering system 100. Communication with external devices, such as a local computer, a remote server, a robot for performing the soldering, a printer and the like, may be performed at the work stand 140 by wired and/or wireless connections, using the known wired and/or wireless interfaces and protocols.

The hand piece 130 includes a solder tip or heater tip 150, a resistance temperature detector (RTD) 160, a coil 170 to generate a magnetic field, a magnetic shield 170, a ceramic insulator 180, a front shaft 190, shrink tube 200, 210, a connector 220 for both electrical and mechanical connections (e.g., to a hand-piece or robot arm for efficient, quick-release operation), and a rear shaft 230.

In one or more embodiments, the microprocessor/processor and the associated circuits provide temperature profiling, allowing the operator to set multiple tip temperatures at fixed times and/or self-adjusting times during a solder event.

In an exemplary first or fixed-time temperature profile, for a solder event, during startup or Zone 1, the solder tip 150 is set to a temperature of 120 C for 2 seconds, then during soak or Zone 2, the solder tip 150 is set to a temperature of 180 C for 2 seconds, then during reflow or Zone 3, the solder tip 150 is set to a temperature of 250 C for 1.5 seconds, and finally during cooling or Zone 4, during which the solder tip 150 does not have physical contact to the joint, the solder tip 150 is allowed to naturally cool down to room temperature.

In an exemplary second or adjustable-time temperature profile, for a solder event, during startup or Zone 1, the solder tip 150 is ramped up for x seconds (as much time as it takes) to a temperature of 120 C, then during soak or Zone 2, the solder tip 150 is ramped up for y seconds (as much time as it takes) to a temperature of 180 C, then during reflow or Zone 3, the solder tip 150 is ramped up to a temperature of 250 C for z seconds (as much time as it takes), and finally during cooling or Zone 4, during which the solder tip 150 does not have physical contact to the joint, the solder tip 150 is allowed to naturally cool down to room temperature.

In an exemplary third or combination fixed-time and adjustable-time temperature profile, for a solder event, during startup or Zone 1, the solder tip 150 is set to 120 C for 1 second and then ramped up to a temperature of 120 C, then during soak or Zone 2, the solder tip 150 is ramped up for x seconds (as much time as it takes) to a temperature of 180 C, then during reflow or Zone 3, the solder tip 150 is set to 250 C for 2 seconds, and finally during cooling or Zone 4, during which the solder tip 150 does not have physical contact to the joint, the solder tip 150 is allowed to naturally cool down to room temperature.

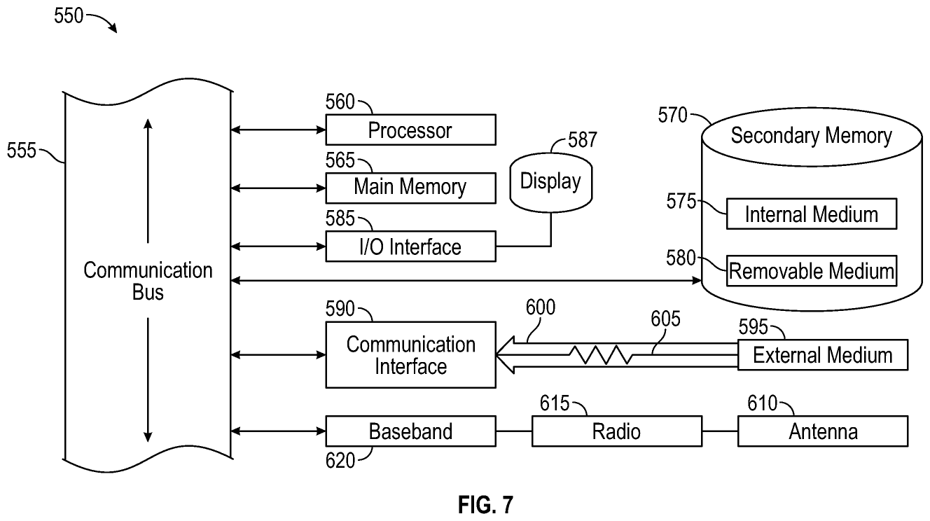

FIG. 7 is a block diagram illustrating an example wired or wireless system 550 that may be used in connection with various embodiments described herein. For example the system 550 may be used as or in conjunction with the microprocessor/processor/controller temperature profiling function(s) described herein. The system 550 can be a conventional personal computer, computer server, personal digital assistant, smart phone, tablet computer, or any other processor enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

System 550 preferably includes a main memory 565 and may also include a secondary memory 570. The main memory 565 provides storage of instructions and data for programs executing on the processor 560. The main memory 565 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 570 may optionally include an internal memory 575 and/or a removable medium 580, for example a floppy disk drive, a magnetic tape drive, a compact disc (“CD”) drive, a digital versatile disc (“DVD”) drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 570. Examples of external storage medium 595 may include an external hard disk drive or an external optical drive, or and external magneto-optical drive.

Other examples of secondary memory 570 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage media 580 and communication interface 590, which allow software and data to be transferred from an external medium 595 to the system 550.

System 550 may also include an input/output (“I/O”) interface 585. The I/O interface 585 facilitates input from and output to external devices. For example the I/O interface 585 may receive input from a keyboard or mouse and may provide output to a display 587. The I/O interface 585 is capable of facilitating input from and output to various alternative types of human interface and machine interface devices alike.

System 550 may also include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a modem, a network interface card (“NIC”), a wireless data card, a communications port, a PCMCIA slot and card, an infrared interface, and an IEEE 1394 fire-wire, just to name a few.

Communication interface 590 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

The system 550 also includes optional wireless communication components that facilitate wireless communication over a voice and over a data network (or otherwise described herein). The wireless communication components comprise an antenna system 610, a radio system 615 and a baseband system 620. In the system 550, radio frequency (“RF”) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown) that are executable by processor 560.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above figures may depict exemplary configurations for the invention, which is done to aid in understanding the features and functionality that can be included in the invention. The invention is not restricted to the illustrated architectures or configurations, but can be implemented using a variety of alternative architectures and configurations. Additionally, although the invention is described above in terms of various exemplary embodiments and implementations, it should be understood that the various features and functionality described in one or more of the individual embodiments with which they are described, but instead can be applied, alone or in some combination, to one or more of the other embodiments of the invention, whether or not such embodiments are described and whether or not such features are presented as being a part of a described embodiment. Thus the breadth and scope of the present invention, especially in the following claims, should not be limited by any of the above-described exemplary embodiments.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although item, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

I/We claim:

1. A soldering iron with temperature profiling, comprising:
a hand piece or a robot arm including a soldering tip;
a processor configured to:
provide temperature profiling where the soldering tip is one or more of the following during a soldering event:
provided at multiple tip temperatures at fixed times during the soldering event; and
provided at multiple tip temperatures at self-adjusting times during the soldering event.

2. The soldering iron of claim 1, further including a power supply unit.

3. The soldering iron of claim 2, further including a stand.

4. The soldering iron of claim 3, wherein the processor is in one or more of the stand, the power supply, and the hand piece or robot arm.

5. The soldering iron of claim 1, wherein the soldering iron includes a hand piece, and the handpiece includes the solder tip, a resistance temperature detector (RTD), a coil to generate a magnetic field, and a magnetic shield.

6. The soldering iron of claim 5, wherein the handpiece includes a ceramic insulator.

7. The soldering iron of claim 6, wherein the handpiece includes a shaft, shrink tube, and a connector.

8. The soldering iron of claim 1, wherein the processor is configured to provide temperature profiling where the soldering tip is provided at multiple tip temperatures at fixed startup, soak, and reflow times during the soldering event.

9. The soldering iron of claim 1, wherein the processor is configured to provide temperature profiling where the soldering tip is provided at multiple tip temperatures at self-adjusting startup, soak, and reflow times during the solder event.

10. The soldering iron of claim 1, wherein the processor is configured to provide temperature profiling where the soldering tip is provided at multiple tip temperatures at both of the following during the soldering event:
one or more fixed startup, soak, and reflow times; and
self-adjusting startup, soak, and reflow times.
